(19) United States
(12) Patent Application Publication
(10) Pub. No.: US 2010/0127830 A1
(43) Pub. Date: May 27, 2010

(54) PORTABLE CARD WITH AN RFID COIL

(76) Inventors: Finn Nielsen, Copenhagen (DK); Rune Domsten, Bronshoj (DK)

Correspondence Address: JACOBSON HOLMAN PLLC, 400 SEVENTH STREET N.W., SUITE 600, WASHINGTON, DC, 20004, US

(21) Appl. No.: 12/450,913

(22) PCT Filed: Apr. 17, 2008
(86) PCT No.: PCT/EP2008/054673

§ 371 Date: Oct. 19, 2009

Related U.S. Application Data
(60) Provisional application No. 60/907,888, filed on Apr. 20, 2007.

(51) Int. Cl. H04Q 5/22

(52) U.S. Cl. 340/10.1

(57) ABSTRACT

An RFID-type system is described in which a portable card receives a signal from a transceiver and outputs a phase modulated or amplitude modulated signal from which the transceiver derives information transmitted from the card. Alternatively, the card may have a coil with a self inductance of 3 mH or more which, by altering the characteristics of the coil or a circuit connected thereto (loading the coil) facilitates a loading of the signal from the transceiver, which load change may be used for extracting the additional information.

The present invention relates to a novel type of RFID element, such as in the shape of a portable card, for communication with an RFID reader.

Typical RFID tags or elements are very simple elements adapted to receive an electromagnetic field, normally a radio signal, harvest energy there from and use this energy to energize a coil to load the sensed field. This loading of the field is performed in accordance with stored data and normally as an amplitude modulation of the field, which may be detectable by a reader, whereby a data transfer takes place.

However, normally, the operating range is quite limited, and the tags and communication is limited to a particular frequency.

In a first aspect, the invention relates to a system for communicating in a wireless manner, the system comprising:
a first element comprising first providing means for providing a first electromagnetic field/signal of a first frequency or wavelength and having a first phase,
a second element comprising:
   means for detecting the first electromagnetic field and the first phase and
   second providing means for providing and outputting a second electromagnetic field/signal having the first frequency or wavelength, a phase opposite to the first phase, and comprising therein additional information,
      the first element being adapted to detect the second electromagnetic field and to derive there from the additional information.

In this context, the first and second fields or signals are electromagnetic fields, such as RF signals. Standard RFID tags use one of four frequency intervals (low frequency: 125-135 kHz (ISO 18000), high frequency: 13.56 MHz (ISO18000-3), ultra high frequency: 865-868 MHz (ISO 18000-6, EPC GEN2, ETSI 302-208), and microfrequency: 2.45 GHz (ISO 18000-4)).

Naturally, the first field may comprise additional frequencies or phases. Normally the first frequency is a carrier frequency which the second element searches for in order to determine whether the first and second elements are in reach of each other.

The second element provides a second field/signal of an opposite phase to that of the first field/signal. This opposite phase is a phase not identical to the first phase. Depending on the detection scheme of the first element, it may be desired to rotate the opposite phase more or less compared to the first phase. Naturally, a phase shifting will slightly and shortly shift the frequency in order to shift the phase, but the actual modulation is the different phase and not the brief frequency shift required to shift the phase. In spite of this, the signal, when modulated, will have the same frequency, in the present context.

The first element will detect a combination of the first and second signals.

A simple detection scheme is one in which the strength or load of the first field is determined. Providing the opposite phase 180 degrees rotated (inverted phase) in relation to the first phase will dampen or attenuate (and thereby act as a load on) the first field and thereby generate a second field of the same phase and frequency of the first field. Information from second element is provided by changing the amplitude of the inverted phase of the second element phase.

Another detection scheme is based on a phase shifting of the second field/signal compared to the first signal. In this manner, the presence of both signals will be analogous to an amplitude modulation. Consequently, phase modulation and amplitude modulation are equally useful.

In addition, frequency shifting or modulation is useful.

Another aspect of the invention relates to a system for communicating in a wireless manner, the system comprising:
a first element comprising first providing means for providing a first electromagnetic field/signal having a first frequency of at least 125 Khz,
a second element comprising a second providing means comprising:
   an electrical circuit comprising a coil having a self induction of at least 3 mH, and
   means for loading the coil in accordance with the predetermined information,
      the first element further comprising means for:
detecting a load of the first electromagnetic field, and
extracting the predetermined information from the detected load.

In this connection, the providing of a coil of a large self induction in the field automatically loads the field from the first element when loading the coil.

The self induction of at least 3 mH gives a rather wide band antenna, which may be desirable if communication using different frequencies is desired.

Preferably, the self inductance of the coil is 4 mH or higher, such as 6 mH or higher. Naturally, the self inductance of the coil may be adapted by e.g. introducing a magnetically inducible material as core for the winding(s) of the coil.

Preferably the coil is provided with a core material which acts as a magnetic conductor in a wide frequency span and which in it self will be able to load the first electromagnetic field if it is present in this.

Load variations can be obtained by electrically loading or shorting the coil windings or by changing the magnetic properties of the coil by changing the saturation level of the core material, e.g.

In both of the above aspects, it is preferred that the second element is portable and that the second providing means comprises:
an electromagnetically inducible material extending along (such as parallel thereto and slightly below) a surface of the second element,
one or more windings—the coil—of an electrically conducting material, the winding(s) being provided around the electromagnetically inducible material,
a controller adapted to provide an electrical signal to the winding(s).

Actually, this coil and inducible material may be positioned at the position where the magnetic strip of standard credit cards is positioned. Then, this coil may also be used for emulating a magnetic strip. This is further described in WO2005/086102, which is hereby incorporated by reference.

According to the first aspect, the controller may be adapted to sense an electrical signal generated in the winding(s) by the first signal and thereby also form the function of the detecting means detecting the first field and the first phase.

Thus, the same coil may be used for sensing the signal and for outputting the second signal. This second signal may simply be generated by loading the field by loading the windings of the coil.

In general, the second element preferably comprises a data storage, and wherein the additional information relates to data stored in the data storage. This additional data may relate to the identity of an owner or user or to account information relating to a banking account of (or related to) the owner or user. This data may be encrypted etc. as it may be confidential to the user/owner.

Preferably, the second providing means are adapted to provide the additional information in the second field by amplitude modulation. Alternatively, the second providing means may modulate the loading, such as over time, in accordance with the additional information.

In a preferred embodiment, the second element further comprises a power source for providing power to the second providing means. This has the advantage that the operations of the second providing means may be performed faster, compared to the situation where the coil first has to harvest sufficient energy for the providing means to operate. Also, the impact provided by in particular the first aspect on the first field may be made much larger in that a larger amount of power may be available for generating the second field.

In a particular embodiment, the second element further comprises means for obtaining a biometric parameter from a user, compare the parameter to information stored in a storage means of the second element, and control the second providing means to only provide the second field, if the parameter corresponds to the stored information.

This may be part of a system in which the data transferred is private and should not be available to everybody. Thus, the data in the data storage may be encrypted as may the data communication via the first and second fields.

In fact, the communication between the first and second elements may be two-way communication, where the first element provides data to the second element, which only operates the second providing means, if the data from the first element (such as the identity thereof) is acceptable.

In a particularly interesting embodiment, the second element comprises means for determining or estimating a signal strength of the detected first electromagnetic field and to adapt a signal strength of the second electromagnetic field/signal and/or the loading accordingly. More particularly, it may be desired to output a higher signal strength or a higher loading of the second field/signal, if the received signal strength of the first signal is low, as this may be taken as an indication that the first element is far away and that a higher signal strength of the second signal or a higher loading is required to reach the first element.

This embodiment may be obtained in a number of manners. A simple manner is one where, if the signal strength of the first signal is below a certain threshold, a first, higher signal strength of the second signal and/or loading is used, and if the signal strength of the first signal is above the threshold, a second, lower signal strength of the second signal and/or loading is used,

Alternatively, a larger number of thresholds may be used, or a calculation may be used for converting the signal strength of the first signal into that required or desired of the second signal and/or loading.

A third aspect relates to an element for use as the second element in the system of the first aspect, the element comprising:
means for detecting the first electromagnetic field and the first phase and
second providing means for providing and outputting the second electromagnetic field having the first frequency or wavelength, the phase opposite to the first phase, and comprising therein the additional information.

Also, a fourth aspect relates to an element for use as the second element in the system of the second aspect, the element comprising:
an electrical circuit comprising a coil having a self induction of at least 3 mH, and
means for loading the coil in accordance with the predetermined information.

As indicated above, in the third or fourth aspects, preferably the element is portable and comprises:
an electromagnetically inducible material extending along a surface of the second element,
one or more windings—the coil—of an electrically conducting material, the winding(s) being provided around the electromagnetically inducible material,
a controller adapted to provide an electrical signal to the winding(s).

In the present context, generally, the second element is portable when it may be carried by a person. Preferred dimensions of the second element are those of standard credit cards or ID badges. The desired weight is as low as possible taking into account that electronics and coils are heavier than the plastics materials normally used for credit cards, e.g.

In relation to the third or fourth aspects, the detecting means are preferably formed by the controller also being adapted to sense an electrical signal generated in the winding(s) by the first signal.

In general, the element preferably further comprises a data storage, and wherein the additional information relates to data stored in the data storage.

In addition, the second providing means may be adapted to provide the additional information in the second field by amplitude modulation. Alternatively, the additional information may be provided in the loading by modulating the loading, such as over time.

Furthermore, advantages are seen when the element further has a power source for providing power to the second providing means.

Finally, the element preferably further comprises means for obtaining a biometric parameter from a user, compare the parameter to information stored in a storage means, and control the second providing means to only provide the second field, if the parameter corresponds to the stored information.

As mentioned above, the element preferably further comprises means for determining or estimating a signal strength of the detected first electromagnetic field and to adapt a loading and/or a signal strength of the second electromagnetic field/signal accordingly.

A fifth aspect of the invention relates to a method of operating the system of the first aspect, the method comprising:
the providing means of the first element providing the first electromagnetic field of the first frequency or wavelength and having the first phase,
the detecting means of the second element detecting the first electromagnetic field and the first phase,
the second providing means providing and outputting the second electromagnetic field having the first frequency or wavelength, the phase opposite to the first phase, and comprising therein the additional information, and
the first element detecting the second electromagnetic field and deriving there from the additional information.

As mentioned, the first element normally would detect the load on the first field caused by the second field, i.e. a combination of the first and the second field.

A sixth aspect relates to a method of operating the system of the third aspect, the method comprising:
the providing means of the first element providing the first electromagnetic field of the first frequency or wavelength, being 125 Khz or higher, and having the first phase,
the second providing means loading a coil having a self induction of at least 3 mH and which is present in the first field to load the first field in relation to predetermined information, and
the first element detecting the loading of the first field and deriving there from the additional information.

In general, the step of providing the second field preferably comprises providing an electrical signal to windings—the coil—of an electrically conducting material, the winding(s) being provided around an electromagnetically inducible material extending along a surface of the second element.

Also, in relation to the fifth or sixth aspects, the detecting step then preferably comprises the controller sensing an electrical signal generated in the winding(s) by the first signal.

Normally, the step of providing the second field or the loading comprises reading the additional data from a data storage.

Preferably, the step of providing the second field comprises providing the additional information in the second field by amplitude modulation. Also, the loading may be provided by modulation, such as over time, of the loading in order to incorporate therein the additional data.

Also, it is preferred to further have the step of a power source providing power to the second providing means.

In a number applications, it is desired to further have the steps of obtaining a biometric parameter from a user, comparing the parameter to information, and only providing the second field, if the parameter corresponds to the stored information.

As indicated above, in a particularly interesting embodiment, the method further comprises the step of the detecting means detecting or estimating a signal strength of the first electromagnetic field and wherein the loading step or the step of the second providing means providing and outputting the second electromagnetic field comprising loading or outputting the second electromagnetic field/signal with a signal strength adapted to the detected or estimated signal strength. A number of manners exist of actually obtaining this effect.

A seventh aspect of the invention relates to a method of operating the element of the third aspect, the method comprising:
detecting the first electromagnetic field and the first phase and
providing and outputting the second electromagnetic field having the first frequency or wavelength, the phase opposite to the first phase, and comprising therein additional information.

An eighth aspect relates to a method of operating the element of the fourth aspect, the method comprising:
positioning the coil of the second providing means in the first field/signal, and
the second providing means loading the coil in relation to predetermined information.

Then, the step of loading or providing the second field preferably comprises loading or providing an electrical signal to windings—the coil—of an electrically conducting material, the winding(s) being provided around an electromagnetically inducible material extending along a surface of the second element.

In relation to the seventh or eighth aspects, a step may then be performed of sensing an electrical signal generated in the winding(s) by the first signal.

Preferably, the providing step comprises reading the additional information from a data storage.

Also, the step of providing the second field preferably comprises providing the additional information in the second field by amplitude modulation. The step of providing the loading of the first field preferably comprises modulating the loading, such as over time, in order to incorporate the additional information therein.

In addition, the step of a power source providing power to the second providing means may be performed in order to be able to perform a faster operation and/or generate a larger impact on the first field.

Also, the method may further comprise the steps of obtaining a biometric parameter from a user, comparing the parameter to information, and only providing the second field, if the parameter corresponds to the stored information.

Finally, the detecting step may comprise detecting or estimating a signal strength of the first electromagnetic field and wherein the loading or providing step comprises loading or outputting the second electromagnetic field/signal with a signal strength adapted to the detected or estimated signal strength.

In the following, a preferred embodiment is described with reference to the drawing which illustrates the first and second elements.

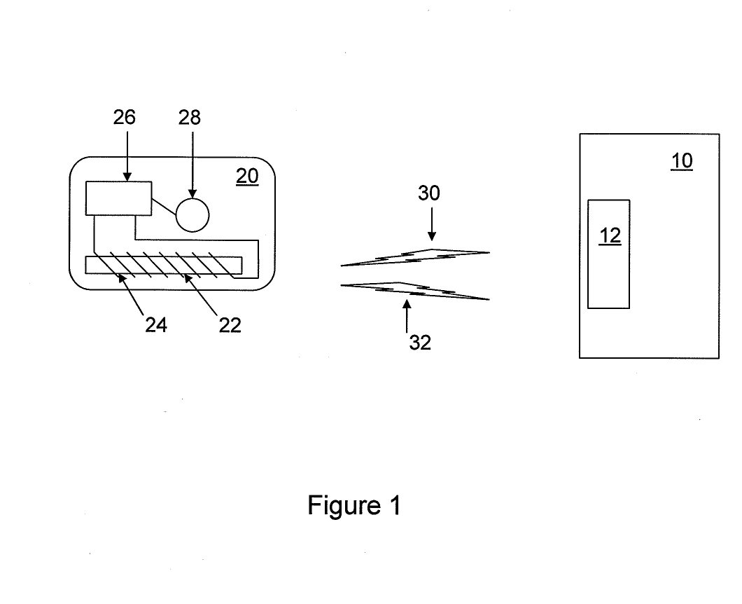

In FIG. 1, a portable card, 20 is provided which has the dimensions of a standard ID or credit card. At the standard position of a magnetic strip of the card 20, a strip 24 of a magnetically inducible material is provided, around which at least one winding 22 of an electrically conducting material is provided for generating a magnetic field in the strip 24.

Preferably, the field provided in the strip 24 may be used to emulate the standard magnetic strip of standard ID cards or credit cards, as is described in e.g. WO2005/086102.

On the card 20, a processor 26 is provided which is operatively connected to the winding(s) 22 in order to sense any signal generated thereby as a result of an electromagnetic field 30 acting on the strip 24 and the winding(s) 22.

In addition, the processor 26, as will be described further below, also is adapted to generate an electrical signal and feed this to the winding(s) 22 in order for the winding(s) 22 and the strip 24 to generate an electromagnetic field 32. The processor receives power from a power source 28, such as a battery, rechargeable or not.

The present system also comprises another element 10 which also has means 12 for generating an electromagnetic field 30 and for receiving and analyzing an electromagnetic field 32.

It is noted that it normally is desired to provide a coil with a relatively large self induction, such as a self induction of 10 μH or more, such as 100 μH or more, such as 1 mH or more, such as 3, 4, 6 mH or more.

The operation of the present system is as follows:

The transceiver 12 outputs a signal 30 with a predetermined frequency and phase. Naturally, the signal need not be of a single frequency. The signal may, a.o. be amplitude modulated, whereby one frequency may be seen as a carrier frequency, and another signal or all types of information may be carried on that carrier frequency.

The signal 30 acts on the strip 24, which generates an electrical signal in the winding(s) 22, and which is transmitted to and sensed by the processor 26.

The processor 26 then determines the phase of the signal 30 and, if not known, the frequency thereof. Before analyzing the signal received from the winding(s) 22, the processor 26 may use a known noise limiting or cancelling technique, including filtering of the signal.

Having now determined the phase, the processor 26 generates a second electrical signal having the frequency of the signal 30 but a phase different there from. This generation may be performed by using e.g. a Phase-Locked Loop for maintaining information about the first phase.

In addition to the frequency and phase determined by the processor 26, the processor 26 adds additional information to the second electric signal in order to transmit this information to the element 10.

The element 10 easily decodes the signal received (signal 32 or a combination of signals 30 and 32) in order to obtain the additional information.

This second electrical signal is forwarded to the winding(s) 22 in order for a corresponding electromagnetic signal 32 to be output by the strip 24.

The transceiver 12, in addition to continuously outputting the signal 30, continuously searches for load changes in signal 30 or the signal 32, which may be seen as a load change of the signal 30. Signal 32, having the same frequency as that of the signal 30, loads the signal 30 if the phase of signal 32 is different and more than 90° shifted from the phase of signal 30. Thus, the transceiver 12 will continuously sense the signal 30, and will, due to the phase difference between the signals 30 and 32, sense the signal 32 as a reduction in field 30.

In fact, also the transceiver 12 may, in the signal 30, introduce information, such as by amplitude/phase/frequency modulation, or by transmitting at multiple frequencies, which then is received by the winding 22 and extracted by the processor 26. On the basis of this information, the card 20 or processor 26 may determine whether to output the signal 32 at all. Thus, the transceiver 12 may identify itself to the card 20 or may, on the basis of the information in the signal 30, specify a mode of operation of the card 20, such as parameters of the signal 32.

When the processor 26 has decided that a response is desired, or if no such determination is required (such as when the card 20 always responds), the card 20 operates as described above.

In a particularly interesting embodiment, the element 20 is adapted to determine or estimate the signal strength of the signal 30. This strength may be compared to one or more threshold values in order to determine a signal strength desired of the signal 32 in order for it to reach the element 10.

These thresholds may be used for correlating a received signal strength to a transmitting signal strength. A simple example is one wherein, if the strength of the signal 30 is below a certain threshold, a first, higher signal strength of the signal 32 is used, and if the strength of the signal 30 is above the threshold, a second, lower signal strength of the signal 32 is used. Naturally, any number of thresholds may be used, as may a calculation converting the received signal strength into the output signal strength.

In this manner, the received signal strength may be interpreted as a distance or a quantification of obstacles between the elements 10 and 20, and this is converted into an output signal strength required or desired in order to ensure that the signal 32 reaches the element 10.

In another embodiment, the signal 32 is a signal having the frequency and phase of the signal 30 but which is amplitude modulated. Thus, the element 10 then receives a signal (32 or a combination of the signals 30 and 32) from which the additional information may easily be determined.

In an alternative embodiment, the processor 26 is adapted to effectuate a change in the electrical properties of the coil/winding 22 or an electrical circuit comprising the coil/winding 22 instead of, or in addition to, the providing of a current thereto. Alternatively, the magnetic properties of the coil 22 may be altered, such as changing the saturation level of the core material 24.

When changing the magnetic properties of the coil 22, the amount of the signal 30 absorbed/attenuated/loaded will vary, which is detectable by the transceiver 12. The changing of the saturation level may be obtained by feeding a DC voltage into the coil 22.

The changing of the electrical properties of the coil 22 may be a shorting of windings thereof, which also will facilitate a detectable change in the loading of the field or signal 30.

The altering of the properties of an electrical circuit comprising the coil 22 may be the providing of e.g. a resistor which is adapted to absorb energy provided by the coil 22 due to its interference with (loading of) the field 30.

Naturally, all the above loading technologies may be combined, and also other manners of e.g. loading a coil or changing the magnetic properties of a coil will be known to the skilled person.

1-36. (canceled)

37. A system for communicating in a wireless manner, the system comprising:
a first element comprising first providing means for providing a first electromagnetic field/signal of a first frequency or wavelength and having a first phase,
a second element comprising:
means for detecting the first electromagnetic field and the first phase and
second providing means for providing and outputting a second electromagnetic field/signal having the first frequency or wavelength, a phase opposite to the first phase, and comprising therein additional information,
the first element being adapted to detect the second electromagnetic field and to derive there from the additional information.

38. A system for communicating in a wireless manner, the system comprising:
a first element comprising first providing means for providing a first electromagnetic field/signal having a first frequency of at least 125 Khz,
a second element comprising a second providing means comprising:
an electrical circuit comprising a coil having a self induction of at least 3 mH, and
means for loading the coil in accordance with the predetermined information,
the first element further comprising means for:
detecting a load of the first electromagnetic field and
extracting the predetermined information from the detected load.

39. A system according to claim 37, wherein the second element is portable and wherein the second providing means comprises:
an electromagnetically inducible material extending along a surface of the second element,
one or more windings of an electrically conducting material, the winding(s) being provided around the electromagnetically inducible material,
a controller adapted to provide an electrical signal to the winding(s).

40. A system according to claim 37, wherein the detecting means are formed by the controller being adapted to sense an electrical signal generated in the winding(s) by the first signal.

41. A system according to claim 38, wherein the second element is portable and wherein the second providing means comprises:
an electromagnetically inducible material extending along a surface of the second element,
one or more windings of an electrically conducting material, the winding(s) being provided around the electromagnetically inducible material,
a controller adapted to provide an electrical signal to the winding(s).

42. A system according to claim 37, wherein the second element comprises means for determining or estimating a signal strength of the detected first electromagnetic field and to adapt a loading and/or a signal strength of the second electromagnetic field/signal accordingly.

43. A system according to claim 38, wherein the second element comprises means for determining or estimating a signal strength of the detected first electromagnetic field and to adapt a loading and/or a signal strength of the second electromagnetic field/signal accordingly.

44. An element for use as the second element in the system according to claim 37, the element comprising:
means for detecting the first electromagnetic field and the first phase and
second providing means for providing and outputting the second electromagnetic field having the first frequency or wavelength, the phase opposite to the first phase, and comprising therein the additional information.

45. An element for use as the second element in the system according to claim 38, the element comprising:
an electrical circuit comprising a coil having a self induction of at least 3 mH, and
means for loading the coil in accordance with the predetermined information.

46. An element according to claim 44, which is portable and which comprises:
an electromagnetically inducible material extending along a surface of the second element,
one or more windings of an electrically conducting material, the winding(s) being provided around the electromagnetically inducible material,
a controller adapted to provide an electrical signal to the winding(s).

47. An element according to claim 44, wherein the detecting means are formed by the controller being adapted to sense an electrical signal generated in the winding(s) by the first signal.

48. An element according to claim 45, which is portable and which comprises:
an electromagnetically inducible material extending along a surface of the second element,
one or more windings of an electrically conducting material, the winding(s) being provided around the electromagnetically inducible material,
a controller adapted to provide an electrical signal to the winding(s).

49. An element according to claim 44, further comprising means for determining or estimating a signal strength of the detected first electromagnetic field and to adapt a loading and/or a signal strength of the second electromagnetic field/signal accordingly.

50. An element according to claim 45, further comprising means for determining or estimating a signal strength of the detected first electromagnetic field and to adapt a loading and/or a signal strength of the second electromagnetic field/signal accordingly.

51. A method of operating the system according to claim 37, the method comprising:
the providing means of the first element providing the first electromagnetic field of the first frequency or wavelength and having the first phase,
the detecting means of the second element detecting the first electromagnetic field and the first phase,
the second providing means providing and outputting the second electromagnetic field having the first frequency or wavelength, the phase opposite to the first phase, and comprising therein the additional information, and
the first element detecting the second electromagnetic field and deriving there from the additional information.

52. A method of operating the system according to claim 38, the method comprising:
the providing means of the first element providing the first electromagnetic field of the first frequency or wavelength, being 125 KHz or higher, and having the first phase,
the second providing means loading a coil having a self induction of at least 3 mH and which is present in the first field load the first field in relation to predetermined information, and
the first element detecting the loading of the first field and deriving there from the additional information.

53. A method system according to claim 51, wherein the step of providing the second field comprises providing an electrical signal to windings of an electrically conducting material, the winding(s) being provided around an electromagnetically inducible material extending along a surface of the second element.

54. A method according to claim 53, wherein the detecting step comprises the controller sensing an electrical signal generated in the winding(s) by the first signal.

55. A method according to claim 51, further comprising the step of the detecting means detecting or estimating a signal strength of the first electromagnetic field and wherein the step of loading and/or the step of the second providing means providing and outputting the second electromagnetic field comprising loading and/or outputting the second electromagnetic field/signal with a signal strength adapted to the detected or estimated signal strength.

56. A method according to claim 52, further comprising the step of the detecting means detecting or estimating a signal strength of the first electromagnetic field and wherein the step of loading and/or the step of the second providing means providing and outputting the second electromagnetic field comprising loading and/or outputting the second electromagnetic field/signal with a signal strength adapted to the detected or estimated signal strength.

57. A method of operating the element according to claim 44, the method comprising:
detecting the first electromagnetic field and the first phase and
providing and outputting the second electromagnetic field having the first frequency or wavelength, the phase opposite to the first phase, and comprising therein additional information.

58. A method of operating the element according to claim 45, the method comprising:
positioning the coil of the second providing means in the first field/signal, and
the second providing means loading the coil in relation to predetermined information.

59. A method according to claim 57, wherein the step of providing the second field comprises providing an electrical signal to windings of an electrically conducting material, the winding(s) being provided around an electromagnetically inducible material extending along a surface of the second element.

60. A method according to claim 59, further comprising the step of sensing an electrical signal generated in the winding(s) by the first signal.

61. A method according to claim 57, wherein the detecting step comprises detecting or estimating a signal strength of the first electromagnetic field and wherein the loading and/or providing step comprises loading and/or outputting the second electromagnetic field/signal with a signal strength adapted to the detected or estimated signal strength.

62. A method according to claim 58, wherein the detecting step comprises detecting or estimating a signal strength of the first electromagnetic field and wherein the loading and/or providing step comprises loading and/or outputting the second electromagnetic field/signal with a signal strength adapted to the detected or estimated signal strength.
